(19) United States
(12) Patent Application Publication
(10) Pub. No.: US 2005/0088748 A1
(43) Pub. Date: Apr. 28, 2005

(54) Molded baffles for controlling stray light in an optical system

(75) Inventor: Rodney H. Otteman, Aloha, OR (US)

Correspondence Address: STOEL RIVES LLP, 900 SW FIFTH AVENUE, SUITE 2600, PORTLAND, OR, 97204, US

(73) Assignee: Leupold & Stevens, Inc., Beaverton, OR (US)

(21) Appl. No.: 10/827,942

(22) Filed: Apr. 19, 2004

Related U.S. Application Data
(60) Provisional application No. 60/515,340, filed on Oct. 28, 2003.

(51) Int. Cl. G02B 27/00

(52) U.S. Cl. 359/613; 359/601

(57) ABSTRACT

A device for controlling stray light in an optical system comprises a tubular liner positioned over the inside surface of the optical system. Such liners are preferably formed of an elastomeric material by molding and include multiple radially-extending baffle structures, which are spaced apart along the optical path for controlling light incident thereon.

### RELATED APPLICATIONS

This application claims the benefit under 35 USC § 119(e) of U.S. Provisional Application Ser. No. 60/515,340, filed Oct. 28, 2003, which is incorporated herein by reference.

### TECHNICAL FIELD

The field of the invention relates to optical systems such as riflescopes, telescopes, and binoculars, and, in particular, to baffles for controlling stray light in such optical systems and methods of making such baffles.

### BACKGROUND OF THE INVENTION

Optical systems such as telescopes, riflescopes, spotting scopes, and binoculars typically include one or more objective lenses having relatively large diameters, to thereby increase the amount of light received from a distant object being viewed. One consequence of a large diameter objective lens is that it admits a substantial amount of off-axis light that can reflect off internal surfaces and propagate through the optical system, causing glare and image degradation.

U.S. Pat. Nos. 3,488,103 of Davis, 4,217,026 of Radovich, 4,542,963 of Linlor, 5,121,251 of Edwards, 5,225,931 of Stravroudis, and others, disclose light-reflecting and/or light-absorbing annular baffles of various shapes and configurations that are positioned on the inside surface of a housing of the optical system along the optical path to prevent stray light from propagating through the optical system.

The extreme edges of such baffles may be highly sharpened to reduce light reflection off those edges. To produce a knife-like edge, baffles have been previously machined from metal. Machined metal baffle structures are expensive to manufacture and undesirably add weight to an optical system.

U.S. Pat. No. 5,225,933 of Myers et al. describes low reflectance articles made of a resin, such as polyurethane, containing light absorbing pigments. Such articles include projections for directing incident light to be absorbed by the article. Myers et al. propose forming such articles in bulk sheets by a roll-forming process.

The present inventors have recognized a need for improved devices for controlling stray light in an optical system.

### SUMMARY OF THE INVENTION

A device for controlling stray light in an optical system comprises a tubular liner that may be positioned over the inside surface of a tubular housing or another body of the optical system having a surface extending along an optical path of the optical system. The liner is preferably formed of an elastomeric material by molding or another low-cost method of fabrication and includes multiple radially-extending baffle structures, which are spaced apart along the optical path for controlling light incident thereon.

Methods of making such devices and optical systems including such devices are also disclosed. A preferred method of manufacture comprises applying an elastomeric material over a generally cylindrical or frusto-conical mold surface having multiple radially-extending depressions, and filling the depressions with the elastomeric material to thereby form a tubular liner with multiple radially-extending baffle structures corresponding to the depressions of the mold surface. The elastomeric material preferably remains sufficiently resilient to prevent damage or permanent deformation of the baffle structures when removing the tubular liner from the mold. The methods described herein may be used to form baffles with apexes having radii of approximately 0.003 or less, to prevent stray light from reflecting off the apexes and propagating along the optical path.

Additional aspects and advantages of the invention will be apparent from the following detailed description of preferred embodiments, which proceeds with reference to the accompanying drawings.

### BRIEF DESCRIPTION OF THE DRAWINGS

FIGS. 1 and 2 are respective isometric and end elevation views of a spotting scope employing light-controlling baffles in accordance with a preferred embodiment;

FIG. 3 is a section view of the spotting scope of FIGS. 1 and 2 taken along line 3-3 of FIG. 2, showing a tubular liner with light-controlling baffles installed in an objective end of the spotting scope;

FIGS. 4 and 5 are respective enlarged isometric and cross section views of the tubular liner of FIG. 3 removed from the spotting scope;

FIG. 6 is an enlarged sectional detail view of the circled area 6-6 of FIG. 5, showing the shape of the light-controlling baffles of the liner;

FIG. 7 is a partial sectional view of an optical system including a tubular liner with a sealing lip, in accordance with another embodiment; and

FIG. 8 is a sectional view illustrating a mold used for making the tubular liners of FIGS. 1-7.

### DETAILED DESCRIPTION OF PREFERRED EMBODIMENTS

Throughout the specification, reference to “one embodiment,” or “an embodiment,” or “some embodiments” means that a particular described feature, structure, or characteristic is included in at least one embodiment. Thus appearances of the phrases “in one embodiment,” “in an embodiment,” or “in some embodiments” in various places throughout this specification are not necessarily all referring to the same embodiment. Furthermore, the described features, structures, or characteristics may be combined in any suitable manner in one or more embodiments.

Furthermore, the described features, structures, characteristics, and methods may be combined in any suitable manner in one or more embodiments. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

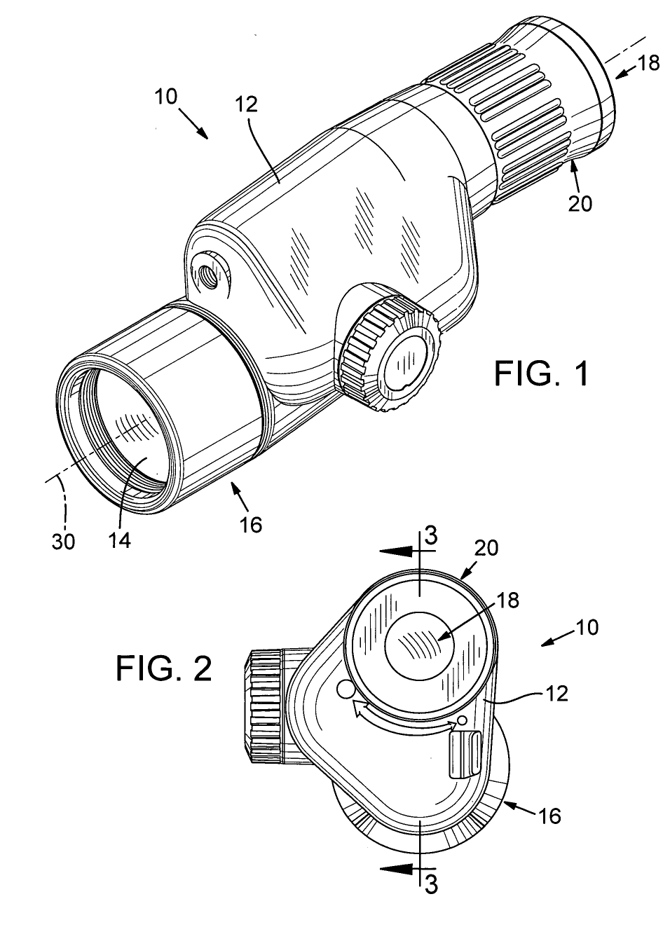

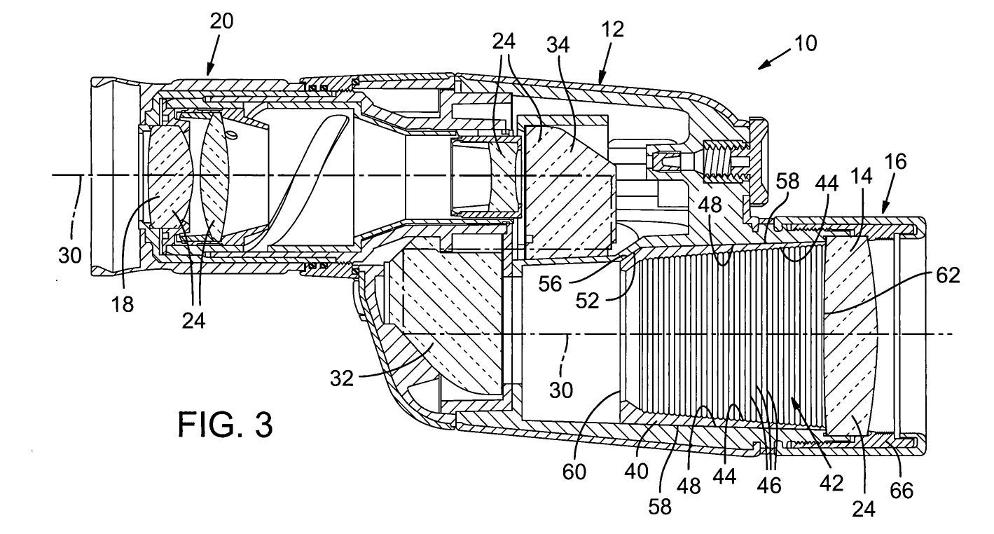

In accordance with a first embodiment optical system, FIGS. 1 and 2 are respective isometric and end elevation views of a spotting scope 10 employing light-controlling baffles. The spotting scope 10 includes a housing 12 supporting an objective 14 (objective lens) proximate an objective end 16 of housing 12, and an eyepiece lens 18 proximate an eyepiece end 20 of housing 12. FIG. 3 is a cross section view of spotting scope 10 taken along line 3-3 of FIG. 2. With reference to FIG. 3, spotting scope 10 includes various optical elements 24 positioned in or along a folded optical path 30 defined by reflective ones of the optical elements 24, including a set of prisms 32 and 34 supported within housing 12. Additional details of spotting scope 10 are set forth in U.S. patent application Ser. No. 10/425,057, filed Apr. 28, 2003, which is incorporated herein by reference.

Many other types of optical systems such as riflescopes, telescopes, and binoculars, for example, include objective lenses and optical paths extending through a housing or along some other body including a reflective surface. Such optical systems may include different types of optical components and optical paths. In some optical systems, light from an observed object is reflected along one or more winding optical paths, as in spotting scope 10. In other optical systems, the optical path follows a generally straight line. In yet other optical systems, the optical path is reflected (without complete folding) or bent, by refraction or otherwise. Accordingly, the terms “optical systems” and “optical path,” as used herein, are not meant to be limited to a particular configuration or shape and should not be limited to the preferred embodiments.

Turning again to FIG. 3, spotting scope 10 includes tubular liner 40 with multiple light-controlling baffles 42 installed in housing 12. FIGS. 4 and 5 are respective enlarged isometric and cross section views of liner 40 removed from spotting scope 10. With reference to FIGS. 3-5, baffles 42 are formed along an inner surface 44 of liner 40 and preferably include multiple annular ridges 46 spaced apart along optical path 30 and positioned near objective 14, to prevent stray light entering objective 14 from propagating further along optical path 30. In other embodiments (not shown) the baffles 42 may include shapes and structures other than annular ridges, such as cones or fins, for example, and may be positioned in other locations along optical path 30, to prevent stray light from reflecting off other surfaces of housing 12 or other bodies or structures along optical path 30. For example, some telescopes include secondary tubes and other structures or bodies within an outer tubular housing, which structures include outwardly facing surfaces. A liner shaped to cover such outwardly facing surfaces (i.e., a sleeve) would include baffles along an outer surface of the liner, rather than along its inner surface.

In a preferred embodiment, liner 40 is positioned to substantially cover a generally frusto-conical portion of inside surface 48 of housing 12. Although liner 40 extends over only a portion of inside surface 48 between objective 14 and prism 32 in this embodiment, other embodiments may include a liner that extends over a greater or lesser portion of inside surface 48. Liner 40 may also be sized to extend the entire length of optical path between objective 14 and prism 42. In still other embodiments, multiple liners with baffles may be included in an optical system, to control stray light along different parts of optical path 30.

The optical design of spotting scope 10 includes in housing 12 an angled ledge 52 along inside surface 48, against which liner 40 is seated. A notch 56 in an outer surface 58 of liner 40 mates with ledge 52, preferably without interrupting the annular shape of the baffles 42 located nearest a proximal end 60 of liner 40. Advantageously, the mating notch 56 and ledge 52 cause liner 40 to be rotationally oriented when installed in housing 12, which may be beneficial in some devices. Objective 14 is secured to housing 12 by an objective ring 66 threaded onto objective end 16, which causes objective 14 to press against a distal end 62 of liner 40 and seat notch 56 against ledge 52, thereby inhibiting movement of liner 40 within housing.

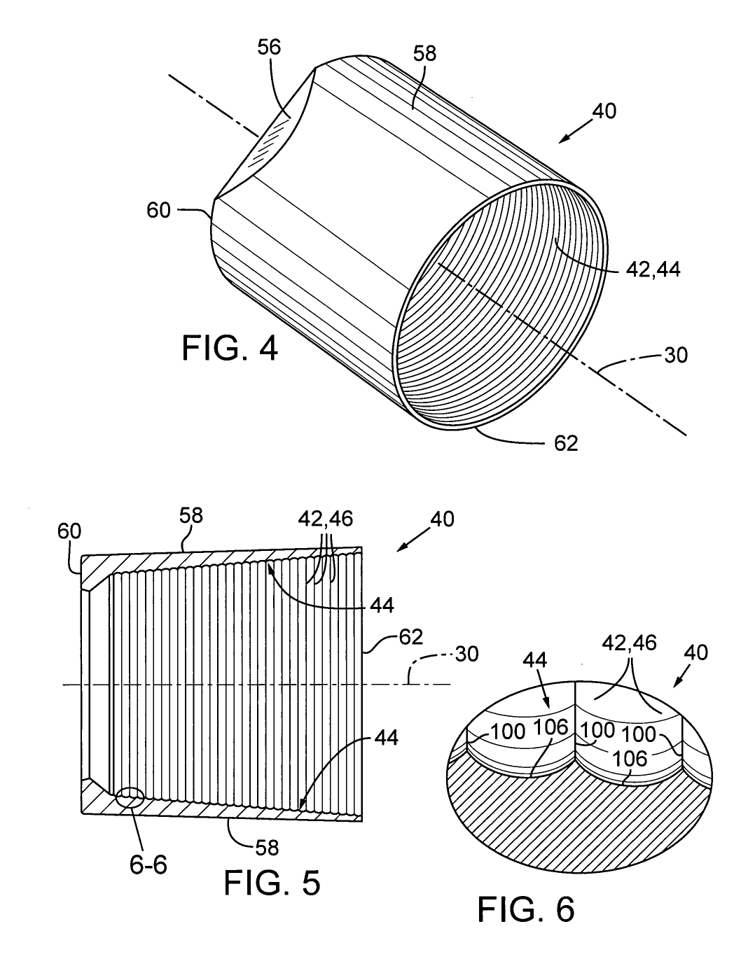

As discussed below with reference to FIG. 6, liner 40 is preferably formed of an elastomeric material for manufacturability and to achieve sharp features needed to prevent stray light from reflecting off baffles 42. The elastomeric material may allow for liner 40 to serve other functions in addition to controlling of stray light.

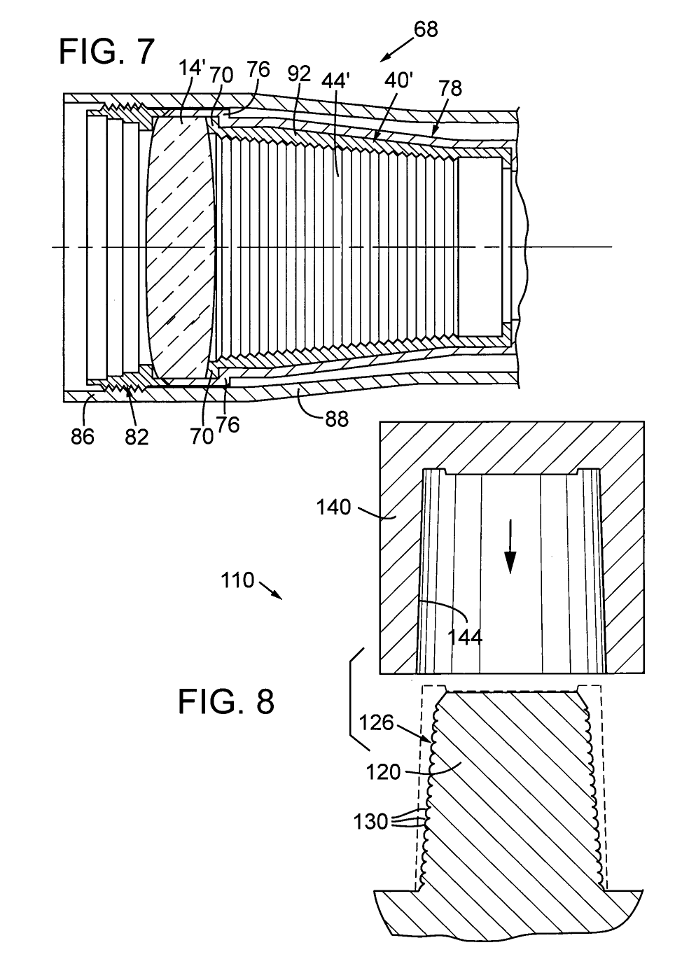

Liners in accordance with some embodiments may also be arranged and constructed to serve as a gas-tight sealing element. FIG. 7 shows an alternative embodiment liner 40′ positioned within an objective end of binoculars 68 (only a portion of one side of binoculars 68 is shown). In FIG. 7, details of inner surface 44′ are omitted for clarity. In this embodiment, liner 40′ includes a radially extending lip 70 near the objective end of liner 40′. Lip 70 is positioned between objective 14′ and a step 76 of an internal structural body 78, and thereafter compressed to provide a seal therebetween. An objective lock ring 82 is screwed into an objective end 86 of a housing 88 of binoculars 68 and tightened to provide a desired amount of compressive force for ensuring a long lasting seal. The seal is preferably hermetic to prevent moisture from entering and dry nitrogen gas from escaping the interior of binoculars 68, thereby inhibiting fogging of internal optical surfaces during cold and/or rainy weather. In the embodiment shown, lip 70 extends radially outward from a main section 92 of liner 40′. However, in other embodiments (not shown) lip 70 may extend inwardly or be shaped differently, to accommodate different sealing arrangements. Lip 70 is preferably integrally formed with a main section 92 of liner 40, for ease of manufacturing. However, in other embodiments (not shown) lip 70 could be formed separately and attached to main section 92, for example by adhesives, sonic welding, or other attachment means.

FIG. 6 is an enlarged sectional detail view of the circled area 6-6 of FIG. 5. As best shown in FIG. 6, baffles 42 include sharp features to reduce the surface area from which incident stray light may reflect and propagate along optical path 30. Baffles 42 preferably include multiple ridges 46 spaced apart along the optical path 30 to redirect and/or absorb incident light. In some types of optical systems, such as the one described in U.S. Pat. No. 4,217,026, other shapes are used to reflect stray light back out the objective end, rather than absorbing it. In the preferred embodiment, each of the ridges 46 extends radially inward to an apex 100 preferably having a radius no greater than approximately 0.003 inch (0.0762 mm). Inner surface 44 of liner 40 includes a rounded trough 106 between adjacent pairs of baffle structures 42. In a preferred embodiment, troughs 106 may have a radius that is greater than the distance between adjacent apexes 100. In other embodiments, troughs 106 may be sharp, as shown in FIGS. 4 and 5 of U.S. Pat. No. 5,121,251, or irregularly shaped, possibly including rounded portions as shown in U.S. Pat. No. 5,225,931, for example.

As mentioned above, liner 40 is preferably molded of an elastomeric material. Molding allows baffles with very fine and sharp features to be efficiently manufactured, thereby eliminating repetitive machining steps required to manufacture prior-art metal baffle structures. Molding of an elastomeric material also facilitates removal of the tubular-shaped liner 40 from the mold. FIG. 8 is a cross section view of an exemplary mold 110, which includes a mold core 120 having a mold surface 126 shaped to define inner surface 44 of liner 40. Mold surface 126 is preferably generally conical or frusto-conical in shape, depending on the shape of liner 40 desired. However, irregularly shaped inner surfaces 44 may also be achieved, by differently shaped cores and mold surfaces. Mold surface 126 includes multiple radially-extending depressions 130 negatively corresponding to the baffle shapes desired.

To make liner 40, an elastomeric material is applied over mold surface 126, filling depressions 130, and allowed to firm until liner can be removed intact from mold 110. Elastomeric material is typically applied while in a gel, paste, fluid or semi-fluid state, for example by spreading it around core 120, or injecting it into a cavity defined by core 120 and a second half 140 of mold 110 when second half 140 is closed against core 120. After firming (by curing, setting, vulcanizing, room temperature vulcanizing, or otherwise), elastomeric material preferably remains sufficiently resilient to peel, slide, or otherwise remove liner 40 from core 120 without causing damage or permanent deformation to baffles 42 and sharp apexes 100. Radiused troughs 106 may help prevent concentration of stresses imparted by flexing baffles 42, to avoid cracking of liner 40 between baffles 42 when removing liner 40 from mold 110. Elastomers may be sufficiently flexible to allow liner 40 to be turned inside-out after molding, reversing the inner 44 and outer 58 surfaces so that the baffles are relocated to project outwardly from the tubular structure. Alternatively, the depressions in the mold surface may be located on a radially outward mold surface 144 within the second half 140 of mold 110. Preferably, however, radially outward mold surface 144 is generally smooth, but may be slightly roughened, by sandblasting or otherwise, to impart a matte finish to outer surface 58 of liner 40. A matte finish on outer surface 58 facilitates sliding of liner 40 within housing 12 with minimal friction during assembly of the spotting scope 10 or another optical device. Other mold surfaces may also be roughened to impart a light-scattering matte surface to other portions of liner 40.

Preferred elastomeric materials include silicone, latex, polyurethane, vinyl polysiloxane, and natural rubber, although other types of rubbers and elastomers may also be suitable. Elastomers such as silicone and polyurethane are preferred for their durability and ability to fill very fine mold features. Moreover, liners 40 formed of elastomeric materials such as silicone are nonconductive and, therefore, have a tendency to attract and hold dust and other small particles, which prevents such particles from becoming lodged on optical surfaces of optical elements 24 and degrading image quality. Light-absorbing pigments such as carbon black may be mixed with elastomers and other moldable materials to create a light-absorbent black liner structure, to further prevent propagation of stray light along the optical path 30. Elastomeric materials such as silicone are minimally abrasive, which helps prevent mold surfaces from degrading, thereby improving manufacturing yields and the quality of sharp features. To help fill depressions 130 and remove bubbles from the elastomer, a vacuum may be drawn around mold 110 during the molding process.

Molding the liner 40 of an elastomeric material allows the forming of apexes 100 having radiuses of less than approximately 0.003 inch (0.0762 mm), and in some embodiments less than approximately 0.002 inch (0.0508 mm). In still other embodiments apexes having radii of less than approximately 0.001 inch (0.0254 mm) may be formed by the methods disclosed herein. Molding of elastomeric materials also allows the formation of baffles having undercut surfaces, which can be useful for directing stray light to prevent it from propagating along the optical path 30.

It will be obvious to those having skill in the art that many changes may be made to the details of the above-described embodiments without departing from the underlying principles of the invention. For example, skilled persons will appreciate that materials other than elastomers may be used to make devices in accordance with the invention and manufacturing methods other than molding may be used to form elastomeric and other such materials into tubular shaped light-controlling liners. The scope of the present invention should, therefore, be determined only by the following claims.

1. A device for controlling stray light in an optical system, comprising a tubular liner formed of an elastomeric material, the tubular liner having an inner surface including multiple radially-projecting baffle structures, the baffle structures shaped for controlling light incident thereon.

2. A device according to claim 1, wherein the baffle structures are formed by molding.

3. A device according to claim 1, wherein the device is formed around a core and the elastomeric material is sufficiently resilient to facilitate removal of the device from the core without damage or permanent deformation of the baffle structures.

4. A device according to claim 1, wherein the elastomeric material is selected from the group consisting essentially of silicone, latex, polyurethane, vinyl polysiloxane, and natural rubber.

5. A device according to claim 1, wherein the elastomeric material includes a light-absorbing pigment.

6. A device according to claim 1, wherein the tubular liner has a length and the baffle structures include multiple annular ridges spaced apart along the length of the tubular liner.

7. A device according to claim 1, wherein each of the baffle structures includes an apex having a radius of approximately 0.003 inch or less.

8. A device according to claim 1, wherein the inner surface of the liner further includes a rounded trough between adjacent pairs of the baffle structures.

9. A device according to claim 1, further comprising a lip integrally formed with the tubular liner and extending radially outward from the tubular liner, the lip adapted to be compressed between axially opposing surfaces in an optical system to form a seal therebetween.

10. In an optical system of the type including a housing having an inside surface, an improved structure for controlling stray light comprising:
a tubular lining formed of an elastomeric material, the lining sized to cover at least a portion of the inside surface of the housing, the lining including multiple radially-extending baffle structures shaped for controlling light incident thereon.

11. A light-controlling device according to claim 10, wherein the baffle structures are formed by molding.

12. A light-controlling device according to claim 10, wherein the elastomeric material is selected from the group consisting essentially of silicone, latex, polyurethane, vinyl polysiloxane, and natural rubber.

13. A light-controlling device according to claim 10, wherein the elastomeric material includes a light-absorbing pigment.

14. A light-controlling device according to claim 10, wherein the tubular lining has a length and the baffle structures include multiple annular ridges spaced apart along the length of the tubular lining.

15. A light-controlling device according to claim 10, wherein each of the baffle structures includes an apex having a radius of approximately 0.003 inch or less.

16. A light-controlling device according to claim 10, wherein the tubular lining further includes a rounded trough between adjacent pairs of the baffle structures.

17. An optical system having an optical path, comprising:
a body having an inside surface extending along the optical path of the optical system; and
a light-controlling tubular lining formed of an elastomeric material and secured within the body to line at least a portion of the inside surface of the body, the lining including multiple radially-extending baffle structures spaced apart along the optical path and shaped for deflecting or absorbing light incident thereon.

18. An optical system according to claim 17, wherein the baffle structures are formed by molding.

19. An optical system according to claim 17, wherein the elastomeric material is selected from the group consisting essentially of silicone, latex, polyurethane, vinyl polysiloxane, and natural rubber.

20. An optical system according to claim 17, wherein the elastomeric material includes a light-absorbing pigment.

21. An optical system according to claim 17, wherein the baffle structures include multiple annular ridges spaced apart along optical path.

22. An optical system according to claim 17, wherein each of the baffle structures includes an apex having a radius of approximately 0.003 inch or less.

23. An optical system according to claim 17, wherein the tubular lining further includes a rounded trough between adjacent pairs of the baffle structures.

24. An optical system according to claim 17, wherein the optical system is selected from the group consisting of a riflescope, a telescope, a spotting scope, and binoculars.

25. An optical system having an optical path, comprising:
a body having an inside surface extending along the optical path of the optical system; and
a molded light-controlling tubular lining positioned in the body to line at least a portion of the inside surface of the body, the lining including multiple integrally-formed baffle structures spaced apart along the optical path and extending radially, the baffle structures each terminating at an apex having a radius of approximately 0.003 inch or less to thereby prevent reflection of light incident thereon.

26. An optical system according to claim 25, wherein the tubular lining is formed of an elastomeric material.

27. An optical system according to claim 25, wherein the radius of each of the apexes is approximately 0.001 inch or less.

28. An optical system according to claim 25, wherein the baffle structures include multiple annular ridges spaced apart along the optical path.

29. A method of manufacturing a structure for controlling the propagation of stray light through an optical system, comprising:
providing a mold including a generally cylindrical or frusto-conical mold surface having multiple radially-extending depressions; and
applying an elastomeric material over the mold surface to form a tubular liner sized to fit in a housing of the optical system, and filling the depressions with the elastomeric material to thereby form on the tubular liner multiple radially-extending baffle structures corresponding to the depressions of the mold surface.

30. A method according to claim 29, wherein:
the mold includes a generally cylindrical or frusto-conical core having an outer surface, the mold surface includes the outer surface of the core, and at least some of the depressions are in the outer surface of the core; and
the applying of the elastomeric material over the mold surface includes applying the elastomeric material around the outer surface of the core.

31. A method according to claim 29, wherein the elastomeric material is sufficiently resilient to prevent damage or permanent deformation of the baffle structures when removing the tubular liner from the mold.

32. A method according to claim 29, wherein the elastomeric material is selected from the group consisting essentially of silicone, latex, polyurethane, vinyl polysiloxane, and natural rubber.

33. A method according to claim 29, further comprising roughening at least a portion of the mold surface before applying the elastomeric material over the mold surface, to thereby impart a matte surface finish to at least a portion of the tubular liner.

34. A method according to claim 29, further comprising:
removing the liner from the mold; and
installing the liner in the optical system so that stray light incident on the baffle structures is prevented from propagating through the optical system.

35. A device made by the method of claim 29.
